(19) United States
(12) Patent Application Publication
(10) Pub. No.: US 2009/0313214 A1
(43) Pub. Date: Dec. 17, 2009

(54) COMMUNICATIONS SYSTEM

(76) Inventors: Douglas Paul Gagnon, Singapore (SG); Tiong Hok Tan, Singapore (SG)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/063,760

(22) PCT Filed: Jul. 14, 2006
(86) PCT No.: PCT/SG2006/000200

§ 371 Date: Aug. 27, 2009

(30) Foreign Application Priority Data
Aug. 16, 2005 (SG) 200505165-1

(51) Int. Cl. G06F 17/30; G06F 15/16

(52) U.S. Cl. 707/3; 709/231; 707/104.1; 707/E17.009; 707/E17.108

(57) ABSTRACT

A communications system (10) for creating and disseminating multimedia content (23) via a network, the system (10) comprising: a web site having: an editor interface (20) to record multimedia content (23), and to enter descriptions (24B) about the recorded multimedia content (23), and a viewer interface (21) to stream the recorded multimedia content (23) via the network for viewing; an index (24A) to indicate the location of the descriptions (24B) and the storage location of the recorded multimedia content (23); wherein the editor interface (20) updates the index (24A) when new multimedia content (23) is recorded and the viewer interface (21) accesses the index (24A) to play the recorded multimedia content (23).

### TECHNICAL FIELD

The invention concerns a communications system for creating and disseminating multimedia content via a network.

### BACKGROUND OF THE INVENTION

The Internet is a very effective distribution channel of information. To increase revenue and improve convenience for some students, some educational institutions offer long distance learning which means students are not required to attend classrooms or lecture theatres. In long distance learning, lecturers place course materials, assessment tasks and examinations on a web site, periodically. Students are then expected to download these materials and study them similar to traditional learning.

Lectures may be recorded and are downloadable by the students. The video and/or audio files of the lectures are usually converted into a widely available video and/or audio streaming format and further compressed to save storage space, They are then streamed via the Internet to the students, on demand. Students are given the flexibility to view and/or listen to the recordings at any time rather than traditionally at fixed times and days. Formatting, compressing and making the video and/or audio files available on a web site require technical prowess which most lecturers do not possess. It is a complicated task, time-consuming and tedious. Thus, it is rare to find many courses available for online long distance learning, and even more difficult to find lecturers creating and disseminating their own material without the assistance of technical support staff. Waiting for the assistance of technical support staff usually tends to delay the publishing of material on the web site which may cause frustration to students expecting some regularity in lectures and course materials.

One clear disadvantage of online distance learning is the lack of interactivity between students and the lecturer compared with a traditional classroom environment. Traditionally, if students have questions, they are able to raise their hands and ask the lecturer, or wait until the lecture ends and talk to their lecturer at that point. In online distance learning, students will either have to telephone their lecturer or send e-mails to their lecturer. Response times will vary according to the lecturer's availability and also the questions and answers may be limited they are provided either in verbal or text form to the student. For example, mathematical formulas, charts and diagrams are difficult to explain over the telephone and slow to produce for an e-mail.

Thus, there is a desire to alleviate at least some of the abovementioned problems encountered with existing online distance learning.

### SUMMARY OF THE INVENTION

In a first preferred aspect, there is provided a communications system for creating and disseminating multimedia content via a network, the system comprising:
a web site having:
   an editor interface to record multimedia content, and to enter descriptions about the recorded multimedia content, and
   a viewer interface to stream the recorded multimedia content via the network for viewing;
an index to indicate the location of the descriptions and the storage location of the recorded multimedia content;
wherein the editor interface updates the index when new multimedia content is recorded and the viewer interface accesses the index to play the recorded multimedia content.

The system may further comprise a counter associated with each multimedia content to track the number of times the multimedia content is viewed, wherein the counter indicates popularity or pedagogical implications of the multimedia content.

The system may further comprise a terminal coupled to a camera and microphone to record the multimedia content.

The multimedia content may relate to a frequently asked question (FAQ) or an answer to a FAQ.

The descriptions may be stored in XML files according to a predetermined XML schema.

Elements of the XML schema may include: faculty code, user name of author, course code, category, question, answer, counter and filename of multimedia content.

The index may be a text file.

The multimedia content may be recorded in Macromedia Flash video file (FLV), RealMedia (RM) or Windows Media Format (WMV) format, or as Java applets.

The system may further comprise a database to store records related to the index and descriptions wherein the database is searched by the viewer interface to improve searching performance of the index and descriptions.

In a second aspect, there is provided a method for creating and disseminating multimedia content via a network, the method comprising:
recording multimedia content, and entering descriptions about the recorded multimedia content, and
streaming the multimedia content via the network for viewing;
indicating the location of the descriptions and the storage location of the multimedia content in an index;
wherein the index is updated when new multimedia content is recorded and the index is accessed to play the recorded multimedia content.

The method may further comprise incrementing a counter associated with each multimedia content to track the number of times the multimedia content is viewed, wherein the counter indicates popularity or success of the pedagogical strategy of the multimedia content.

The method may further comprise storing records related to the index and descriptions in a database wherein the database is searched to improve searching performance of the index and descriptions.

### BRIEF DESCRIPTION OF THE DRAWINGS

An example of the invention will now be described with reference to the accompanying drawings, in which:

FIG. 1 is a block diagram of a communications system of a preferred embodiment of the present invention;

FIG. 2 is a screenshot of the editor interface when a description is being created;

FIG. 3 is a screenshot of the editor interface when video is being recorded;

FIG. 4 is a screenshot of the editor interface showing an overview of descriptions and videos for a course;

FIG. 5 is a screenshot of the viewer interface showing a list of questions and videos available to be viewed;

FIG. 6 is a screenshot of the viewer interface showing a video being played and an answer to a question; and

FIG. 7 is an illustration of the structure of both a description XML file and index.

### DETAILED DESCRIPTION OF THE DRAWINGS

The drawings and the following discussion are intended to provide a brief, general description of a suitable computing environment in which the present invention may be implemented. Although not required, the invention will be described in the general context of computer-executable instructions, such as program modules, being executed by a computer such as a personal computer, laptop computer, notebook computer, tablet computer, PDA and the like. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

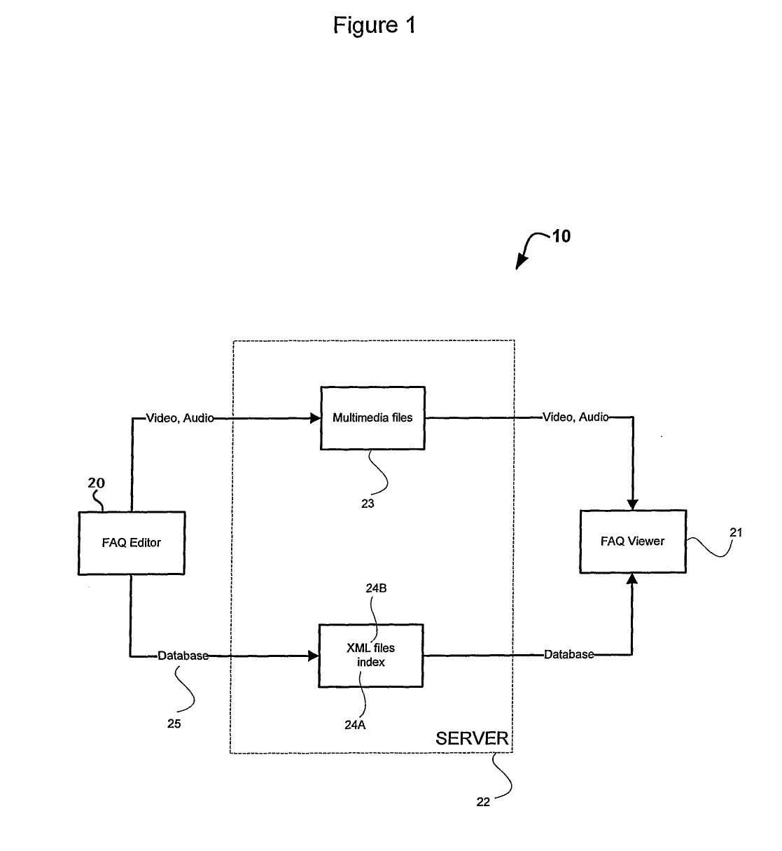

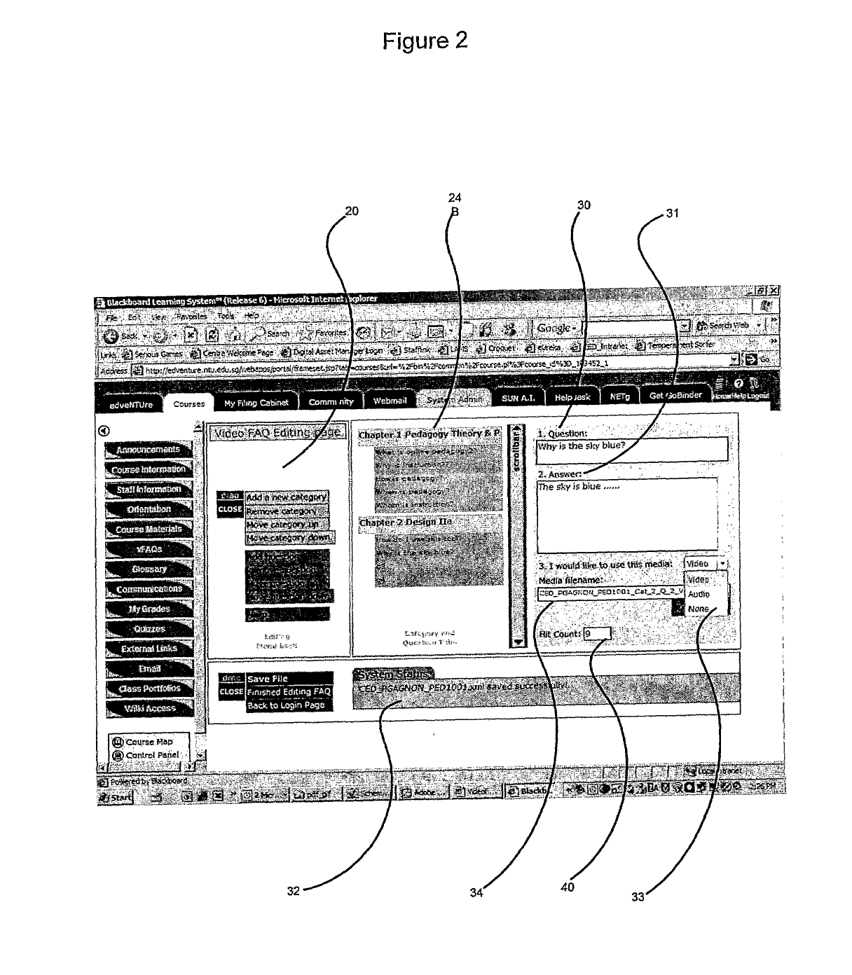

Referring to FIG. 1, a communications system 10 for creating and disseminating multimedia content 23 via a network is provided. In one example, the network is the Internet. The system 10 comprises a web site as depicted in FIG. 2 and an index 24A. The web site has an editor interface 20 and a viewer interface 21. The editor interface 20 records the multimedia content 23, and allows descriptions 24B to be entered about the recorded multimedia content 23. In a learning environment, the multimedia content relates to a frequently asked question (FAQ) or an answer to a FAQ. A terminal such as a desktop computer is coupled to a camera and microphone to record the multimedia content 23 by a lecturer. The desktop computer is connected to the web site via the Internet. Students also have computers with cameras and microphones to record their questions in multimedia form if they desire. The viewer interface 21 streams the recorded multimedia content 23 via the Internet to the student's computer. Each viewer interface 21 has a unique identifier generated by the administrator of the system 10. The index 24A indicates the location of the descriptions 24B and the storage location of the multimedia content 23. The editor interface 21 updates the index 24A when new multimedia content 23 is recorded. The viewer interface 21 accesses the index 24A to locate the description 24B and access the corresponding recorded multimedia content 23 for playback.

The index 24A, descriptions 24B and multimedia files 23 are stored on a server 22. In one example, the server 22 is a Macromedia Flash Communications™ server. The server 22 may also be coupled to a Microsoft.NET™ server to improve server processing performance. Alternatively, a Unix™-based server operating SunOS™ or J2EE server may be used in conjunction with Java applets. In the alternative, rather than relying on a Macromedia™ plugin for the web browser, a Java Virtual Machine is used to view the video 23 via a Java applet executed in the web browser. The Java applet is able to use any video format so long as it has the appropriate codecs to playback the video 23. Using Java™ maximises portability and compatibility for all users with various computing devices due to wide adoption in the market. The server 22 is scalable and is able to handle at least 30,000 video files 23 amounting to around 180 GB in storage space. To ensure good performance, the video files 23 may be stored on a SANS or NAS storage device.

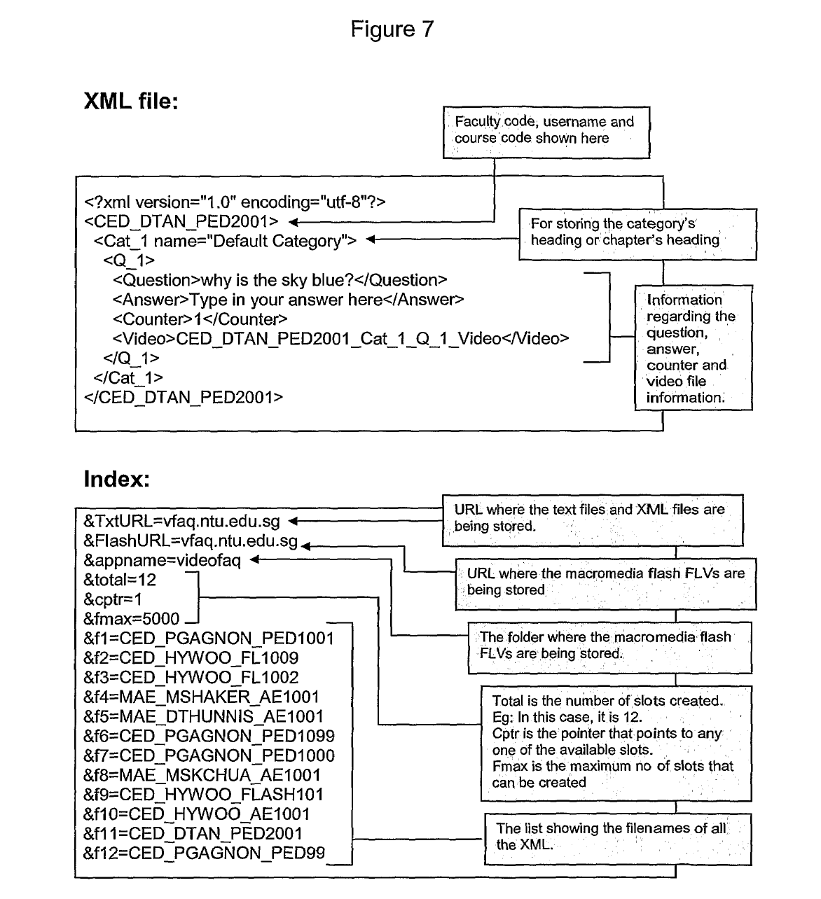

Turning to FIG. 7, the index 24A is a text file, and the descriptions 24B are Extensible Markup Language (XML) files. The index 24A generally includes a Uniform Resource Locator (URL) and directory/folder to identify the storage location of indexes and XML files 24B and also the video files 23. The number of slots is indicated corresponding to the number of video files 23 and also the maximum number of slots permitted for the course/subject. The filename of all the XML files 24B categorized for the course/subject is listed. The XML files 24B follow a predetermined XML schema specifically designed for FAQs. Elements of the XML schema include: faculty code, user name of author, course code, category, question 30, answer 31, counter 40 and filename of multimedia content 34. The elements are indicated in tags <>, such as <Q_{—}1>, <Question> and <Answer>. Some values of these elements are automatically retrieved and completed based on the lecturer's log in to the web site.

A database 25 is provided to store records related to the index 24A and descriptions 24B. The database 25 is updated by the editor interface 20 when new multimedia content 23 is recorded and is searched by the viewer interface 21 to improve searching performance of the index 24A and descriptions 24B when a student is looking for a particular question and wants to view the answer.

The video files 23 are authored by a lecturer or by a student who has a question. In response to a student's question, the lecturer creates a short text-based answer 31 and video answer 23. In one embodiment, to maintain anonymity of the student, the lecturer only publishes the answer 23 on the web site and not the student's video. If the lecturer desires, the answer is classified under the Frequently Asked Questions (FAQ) category for a specific topic, subject or course. A short description of the student's question 30 is associated with the answer 23, 31.

In a typical scenario, the lecturer receives a question 30 from a student and is notified by way of e-mail or by checking the web site for new questions received. The lecturer logs into the web site via a login page and authenticates themselves. Log in procedure requires the lecturer to enter: the faculty code, username, and course code. The editor interface 20 assigns a filename including an empty slot from 1 to 1000 for the multimedia content 23. Turning to FIG. 2, the lecturer creates a chapter and general description 24B to categorise the question 30. The lecturer provides enters a brief text-based answer 31 and then selects the type of multimedia 33 they want to associate with the answer 31. Multimedia types selectable include video, audio or none. A filename 34 for the multimedia 33 is automatically generated by the system 10 or manually entered by the lecturer. For an existing FAQ, the counter 40 has a value corresponding to the number of times the multimedia file 33 has been requested, otherwise the counter 40 will be zero. The counter 40 enables the lecturer to ascertain areas of difficulty for students, as a high number will signify students do not understand the topic well. In response, the lecturer may improve the course materials or spend more time discussing the topic in lectures for subsequent teaching of the course. The counter 40 enables the lecturer to concentrate their teaching efforts on areas which pose more difficulty for students and reduce in areas where there no difficulty is encountered. The lecturer saves this description as an XML file 24B. The status of the XML file 24B is displayed in a system status frame 32 which shows the filename of the XML file 24B. Also, the index 24A is updated and a record is generated for the database 25.

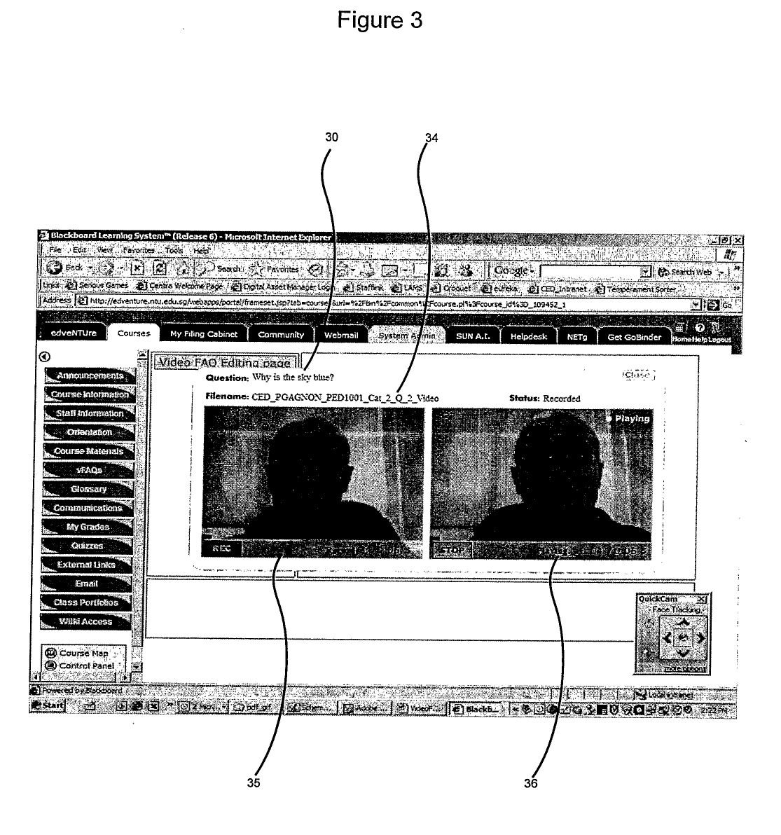

Turning to FIG. 3, a second screen is presented which enables the lecturer to begin recording their answer in multimedia form 23. Two windows are presented: a recording window 35 and a playback window 36. To record the multimedia content 23, the lecturer clicks on the REC button in the recording window 35. The multimedia content 23 is recorded in Macromedia Flash™ video file (FLV) format. Alternatively, other formats such as RealMedia (RM) or Windows Media Format (WMV) may be used. To review the recorded multimedia content 23, the PLAY/STOP button in the playback window 36 is clicked. Above the playback window 36, the status of “Recoded” is displayed to indicate that what is shown in playback window 36 is a pre-recording. If the lecturer is not satisfied with the recording, the REC button is clicked again in the recording window 35 to overwrite the existing recording. Otherwise, the second screen is closed and the recorded multimedia content 23 is associated with the question 30 and answer 31 and made immediately available on the web site.

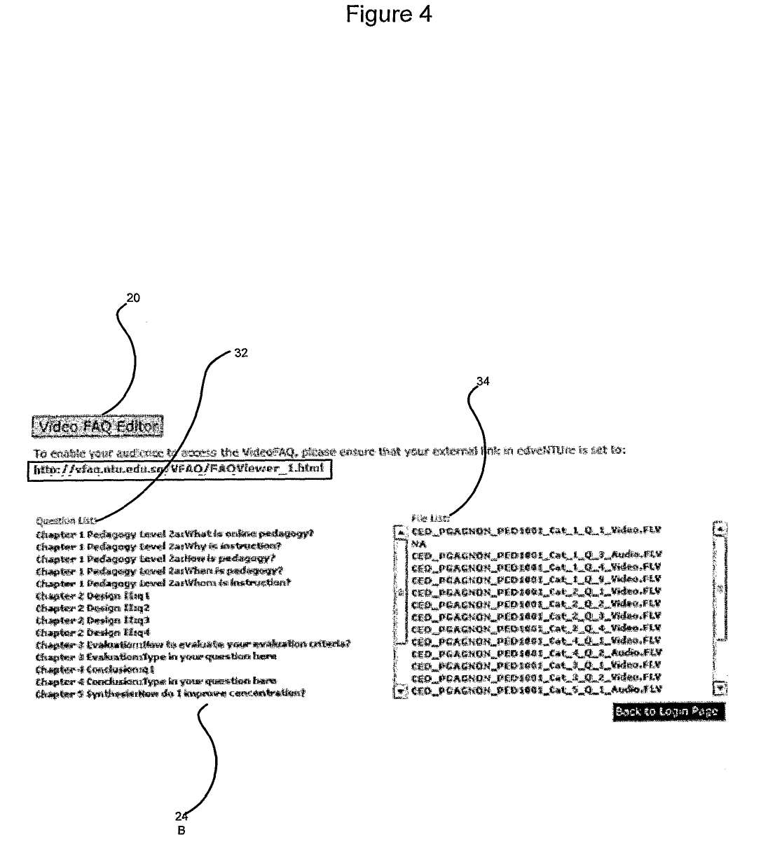

Referring to FIG. 4, a third screen is presented to allow the lecturer to see the concordance between video files 34, descriptions 32 and the student's questions 24B. This provides an overview of what questions 24B and answers 34 have been categorized for a particular course or subject. If there is anything missing, the lecturer will be able to rectify it.

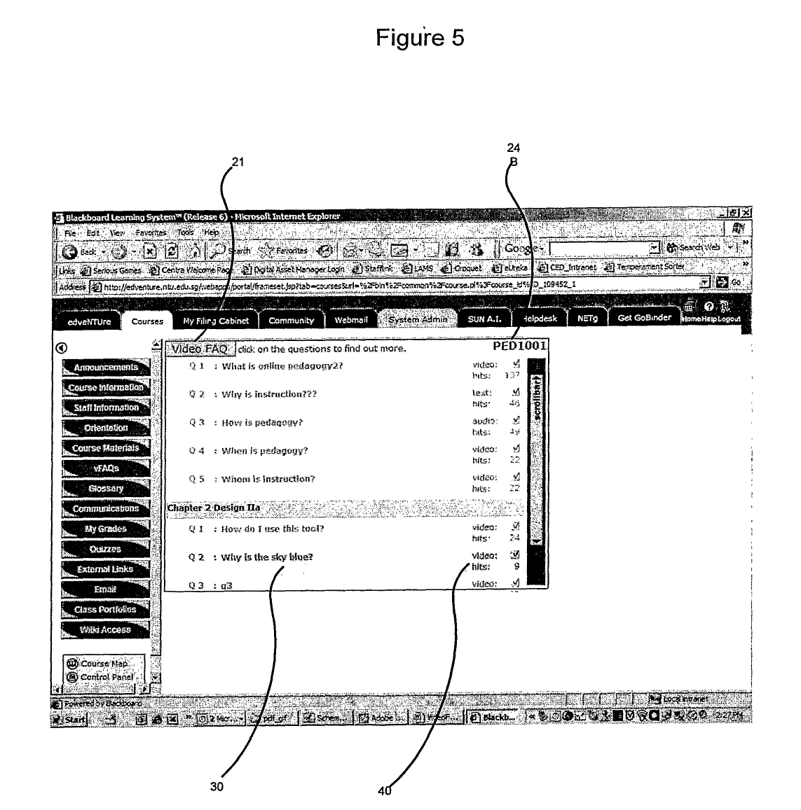

Referring to FIG. 5, the viewer interface 21 is provided to a student to view recorded multimedia content 23. The course and description 24B is displayed in the viewer interface 21. Students scroll in a central window pane to locate questions 30 of interest. Each question 30 has a corresponding answer 34, and the number of times 40 it has been viewed is indicated along with the multimedia type of the answer 34.

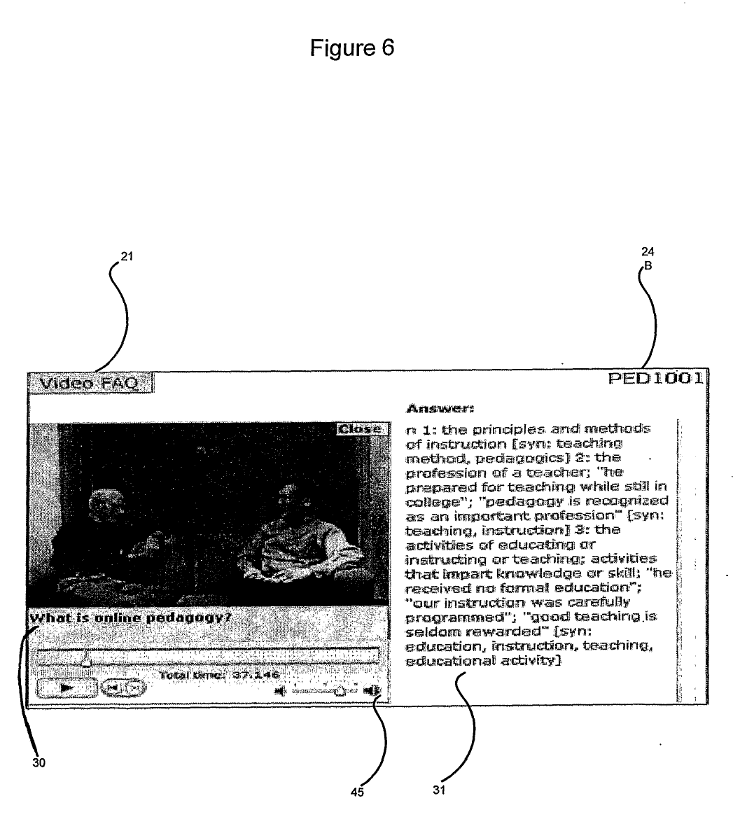

Referring to FIG. 6, after the student has clicked on a question 30 of interest, they are brought to a second screen of the viewer interface 21 which has a playback window 45 similar to the one for the editor interface 20, except larger in size. The question 30 is displayed along with the description 24B and text-based answer 31. In contrast to the editor interface 20, the playback window 45 has a slider to jump to different times of the video and also a volume adjuster to control the volume level.

Although the invention has been described with reference to online distance learning, it is envisaged that large scale business applications are possible. For example, applications include helpdesk within a corporation, technical support for customers or product information for new customers. Such applications require communication between at least two parties, where one party is seeking information or an answer to their problems and questions, and another party who has the information and expertise to resolve their problems and questions.

The present invention introduces greater interactivity, and creates a conducive environment for efficient dissemination of information to end users using a multimedia-based approach. The present invention greatly simplifies the ability to respond to enquiries and create highly engaging multimedia content without expending time and cost to educate existing users in programming languages or new technical skills.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

1. A communications system for creating and disseminating multimedia content via a network, the system comprising:
a web site having:
an editor interface to record multimedia content, and to enter descriptions about the recorded multimedia content, and
a viewer interface to stream the recorded multimedia content via the network for viewing; and
an index to indicate the location of the descriptions and the storage location of the recorded multimedia content;
wherein the editor interface updates the index when new multimedia content is recorded and the viewer interface accesses the index to play the recorded multimedia content.

2. The system according to claim 1, further comprising a counter associated with each multimedia content to track the number of times the multimedia content is viewed, wherein the counter indicates popularity or pedagogical implications of the multimedia content.

3. The system according to claim 1, further comprising a terminal coupled to a camera and microphone to record the multimedia content.

4. The system according to claim 1, wherein the multimedia content relates to one selected from the group consisting of: a frequently asked question and an answer to a frequently asked question.

5. The system according to claim 1, wherein the descriptions are stored in XML files according to a predetermined XML schema.

6. The system according to claim 5, wherein elements of the XML schema include faculty code, user name of author, course code, category, question, answer, counter and filename of multimedia content.

7. The system according to claim 1, wherein the index is a text file.

8. The system according to claim 1, wherein the multimedia content is recorded in at least one selected from the group consisting of: Macromedia Flash video file, Real Media format, Windows Media Format, and Java applets.

9. The system according to claim 1 further comprising a database to store records related to the index and descriptions wherein the database is searched by the viewer interface to improve searching performance of the index and descriptions.

10. A method for creating and disseminating multimedia content via a network, the method comprising:
recording, multimedia content, and entering descriptions about the recorded multimedia content using an editor interface on a website, and
streaming the multimedia content via the network for viewing using a viewer interface on a website;
indicating the location of the descriptions and the storage location of the multimedia content in an index;
wherein the index is updated using the editor interface when new multimedia content is recorded and the index is accessed using the viewer interface to play the recorded multimedia content.

11. The method according to claim 10, further comprising incrementing a counter associated with each multimedia content to track the number of times the multimedia content is viewed, wherein the counter indicates popularity or success of the pedagogical strategy of the multimedia content.

12. The method according to claim 10, further comprising storing records related to the index and descriptions in a database wherein the database is searched to improve searching performance of the index and descriptions.

13. A web server for storing and streaming multimedia content via a network, the web server being configured to:
transmit to a first user, for display in a first user display window, an editor interface for recording, multimedia content for storing on the web server, and to receive from the first user a description of recorded multimedia content;
transmit to a second user for display in a second user display window a viewer interface for streaming recorded multimedia content received via the network for viewing by the second user;
store an index file for indicating a location of a description and a storage location on the web server of recorded multimedia content;
receive an update to the index file from the first user via the editor interface and the network when new multimedia content is recorded; and
to transmit to the second user for display on the viewer interface data from the index file to facilitate access and playback of the recorded multimedia content.

14. The web server according to claim 13, further comprising a counter associated with each multimedia content, the counter being configured to track the number of times the multimedia content is viewed, wherein the counter is further configured to indicate popularity of pedagogical implications of the multimedia content.

15. The web server according to claim 13, further comprising a terminal coupled to a camera and microphone to record the multimedia content.

16. The web server according to claim 13, wherein the descriptions are stored in XML files according to a predetermined XML schema.

17. The web server according to claim 16, wherein elements of the XML schema include: faculty code, user name of author, course code, category, question, answer, counter and filename of multimedia content.

18. The web server according to claim 13, wherein the index is a text file.

19. The web server according to claim 13, further comprising a database, the database being configured to store records related to the index and descriptions; the database being configured to be able to be searched by the viewer interface to improve searching performance of the index and descriptions.
